(19) United States
(12) Patent Application Publication
(10) Pub. No.: US 2007/0293161 A1
(43) Pub. Date: Dec. 20, 2007

(54) Apparatus Connecting at Least One Transmitter Unit to Transceiver Antenna

(76) Inventor: Tilman Felgentreff, Holzkirchen (DE)

Correspondence Address: STAAS & HALSEY LLP, SUITE 700, 1201 NEW YORK AVENUE, N.W., WASHINGTON, DC, 20005, US

(21) Appl. No.: 11/667,452

(22) PCT Filed: Oct. 13, 2005
(86) PCT No.: PCT/EP05/55213

§ 371 Date: May 10, 2007

(30) Foreign Application Priority Data
Nov. 10, 2004 (DE) 10 2004 054 370.4

(51) Int. Cl. H04B 1/04; H04Q 7/30

(52) U.S. Cl. 455/83

(57) ABSTRACT

A transceiver duplex filter has a transmit filter that supplies a transmission signal from at least one transmitter unit to a transceiver antenna. When connected to two transmitter units, two one-way attenuators, each of which is provided with an input and an output, are allocated to respective transmitter units. The input of each one-way attenuator can be connected in a fixed but removable manner to the respective transmitter unit. A coupling device provided with first and second inputs and an output, has a first input connected to the output of the second one-way attenuator. The input of the transmit filter, the second input of the coupling device, the output of the coupling device and the output of the first one-way attenuator may be connected in a fixed but removable fashion, whereby at least one transmission signal of an associated transmitter unit can be selectively connected to the input of the transmit filter by using the fixed but detachable connections.

### CROSS REFERENCE TO RELATED APPLICATIONS

This application is based on and hereby claims priority to German Application No. 10 2004 054 370.4, filed on Nov. 10, 2004, the contents of which are hereby incorporated by reference.

### BACKGROUND

Described below is an arrangement for connecting at least one transmitter unit to a transceiver antenna.

In the case of base stations, so-called “antenna combining receive methods” are used to improve reception. In this context, a subscriber signal transmitted by a subscriber is generally received at the base station as two receive signals by way of two antenna systems. Each individual receive signal is evaluated for instance in consideration of a signal quality or signal level. One of the two receive signals is subsequently selected and further processed for instance.

The two antenna systems are used on the transmit side as transmit antennae for transmission signals. With a TDMA radio communication system for instance, two, four or eight transmitter units, which are referred to as “carrier units”, are generally connected here to the two transmit antennae, with one, two or four transmitter units being provided in each instance for a respective transmit antenna. Each transmitter unit forms here a carrier frequency which is used for a subscriber signal transmission. So-called “Duplexer Amplifier Multicouplers, DUAMCO” are used to connect the carrier frequencies, which generally have a module for each transmit antenna in each instance.

FIG. 4 shows a first arrangement for connecting transmission signals TX1a and TX1b from assigned transmitter units to transceiver antennae ANT1 and ANT2, according to the related art. The arrangement illustrated here is referred to as “DUAMCO 2:2”, i.e. two transmission signals of two transmitter units are connected to two transceiver antennae.

A first module M1 contains a one-way attenuator AS1, to which a first transmission signal TX1a of a transmitter unit (not illustrated here) is connected on the input side. The one-way attenuator can also be realized as an insulator or as a circulator or as a functionally-similar component. The one-way attenuator AS1 is connected on the output side to a transmit filter TX of a transceiver duplex filter DF1.

The transmission signal TX1a reaches the transceiver antenna ANT1 for emission by way of the one-way attenuator AS1, the transmit filter TX and by way of a component BiasTEE.

The component BiasTEE is used to feed a power supply and to supply a signaling for an optional “Tower Mounted Amplifier, TMA”, which is arranged in close proximity to the antenna. To this end, the component BiasTEE is connected to the respective components CTRL and TMA. An antenna monitor is realized with the aid of a component ASU.

The first module M1 also contains two optionally connectable amplifiers LNA11 and LNA12, which are designed as “Low Noise Amplifers, LNA”. A subscriber signal received by the transceiver antenna ANT1 reaches the optionally connectable amplifiers LNA11 and LNA12 by way of the component BiasTEE and by way of a receive filter RX of the transceiver duplex filter DF1. An attenuation facility D1 is additionally provided for influencing the receive signal, the attenuation facility D1 being arranged between the two connectable amplifiers LNA11 and LNA12.

The amplifier LNA12 is connected on the output side to four assigned receiver units or carrier units (not illustrated here) by way of four outputs RX1, RX2, RX3 and RX4.

An output RXCA1 is also coupled to the output of the amplifier LNA12.

The first module M1 is of the same design as a second module M2, which is used to connect the second carrier frequency TX1b of a transmitter unit (not illustrated here) to the second transceiver antenna ANT2. Accordingly, the second module M2 contains a transceiver duplex filter DF2, a component BiasTEE, a one-way attenuator AS2 as well as optionally connectable amplifiers LNA21, LNA22 and an attenuation facility D2.

FIG. 5 shows a second arrangement for connecting four transmitter units to two transceiver antennae according to the related art.

The arrangement illustrated here is referred to as “DUAMCO 4:2”, because four transmission signals from four transmitter units are connected to two transceiver antennae.

A first module M1 is used to connect two transmission signals TX1 and TX2 from two transmitter units (not illustrated here) to a transceiver antenna ANT1.

In comparison with FIG. 4, the first module M1 contains two one-way attenuators AS11 and AS12, which are connected on the output side to respective inputs of a coupling facility Coupler1. The two transmission signals TX1 and TX2 can be connected to the two one-way attenuators AS11 and AS12 on the input side. The one-way attenuators can also be realized in each instance as insulators or as circulators or as functionally-similar components.

With the aid of the coupling facility Coupler1, the two transmission signals TX1 and TX2 are combined and are fed to the transceiver antenna ANT1 for emission by way of a transmit filter TX of a transceiver duplex filter DF1.

Reference is made to the embodiment in FIG. 4 identical in construction with respect to the receiver components and the controllers.

The first module M1 illustrated in FIG. 5 is identical in construction to the second module M2, which can be used to connect two further carrier frequencies from transmitter units (not illustrated here) to the second transceiver antenna ANT2. Accordingly, in addition to the transceiver duplex filter DF2, the second module M2 contains two one-way attenuators AS21 and AS22 as well as a coupling facility Coupler2.

Unused ports of the coupling facilities Coupler 1 and Coupler 2 designed here as 3 dB couplers are terminated in each instance with a load resistor.

FIG. 6 shows a third arrangement for connecting eight transmitter units to two transceiver antennae according to the related art.

The arrangement illustrated here is referred to as “DUAMCO 8:2”, because eight transmission signals from eight transmitter units are connected to two transceiver antennae.

A first module M1 is used to connect four transmission signals TX1, TX2, TX3 and TX4 from four transmitter units (not illustrated here) to a transceiver antenna ANT1.

In comparison with FIG. 5, the first module M1 contains four one-way attenuators AS11, AS12, AS13 and AS14, which are connected on the output side to respective inputs of a coupling facility Coupler1. The four transmission signals TX1 to TX4 can each be individually connected in each instance to the four one-way attenuators AS11, AS12, AS13 and AS14 on the input side.

The one-way attenuators can also be realized in each instance as insulators or as circulators or as a functionally-similar component.

With the aid of the coupling facility Coupler1, the four transmission signals TX1 to TX4 are combined and are fed to the transceiver antenna ANT1 for emission by way of a transmit filter TX of a transceiver duplex filter DF1.

In respect of the receiver components and the controllers, reference is made to the embodiment in FIG. 5 identical in construction, with only the amplifier LNA12 being connected to a total of eight outputs of the first module M1.

The first module M1 illustrated in FIG. 6 is identical in construction to the second module M2, which can be used to connect four further carrier frequencies from transmitter units (not illustrated here) to the second transceiver antenna ANT2. Accordingly, in addition to the transceiver duplex filter DF2, the second module M2 contains a total of four one-way attenuators AS21, AS22, AS23 and AS24 as well as a coupling facility Coupler2.

Unused ports in the coupling facilities Coupler1 and Coupler2 are terminated in each instance with a load resistor.

The arrangements illustrated in FIGS. 4 to 6 are respective fixed components of a base station. The base station would thus only be extendable by a component exchange, which is complex to carry out, of four to eight carrier frequencies or of four to eight transmitter units for instance.

### SUMMARY

Described below is an arrangement to connect one or a number of transmitter units to a transceiver antenna, which can be extended using minimal effort.

The arrangement makes it possible, by using fixed but detachable connections and by adding in an expansion unit as required, starting with one transmission signal and/or transmitter unit, to connect up to four transmitter units and as applicable transmission signals to a transceiver antenna in each instance with little additional effort.

If the arrangement is of a modular design, a “DUCOM 2:2” or a “DUCOM 4:2” or a “DUCOM 8:2” can be realized with minimal effort using two modules.

A subsequent base station expansion to further transmitter units can be implemented with minimal additional effort.

### BRIEF DESCRIPTION OF THE DRAWINGS

These and other objects and advantages will become more apparent and more readily appreciated from the following description of the preferred embodiments, taken in conjunction with the accompanying drawings in which:

FIG. 1 is a block diagram of an arrangement to connect at least one transmitter unit to a transceiver antenna,

FIG. 2 is a block diagram of an expansion unit which can be connected to the arrangement illustrated in FIG. 1 to connect at least three transmitter units to the transceiver antenna,

FIG. 3 is a block diagram of an arrangement having a connected expansion unit with reference to FIGS. 1 and 2,

FIG. 4 is a block diagram of the first arrangement as described in the introductory part of the description to connect two transmitter units to two transceiver antennae according to the related art,

FIG. 5 is a block diagram of the second arrangement as described in the introductory part of the description to connect four transmitter units to two transceiver antennae according to the related art, and

FIG. 6 is a block diagram of the third arrangement as described in the introductory part of the description to connect eight transmitter units to two transceiver antennae according to the related art.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

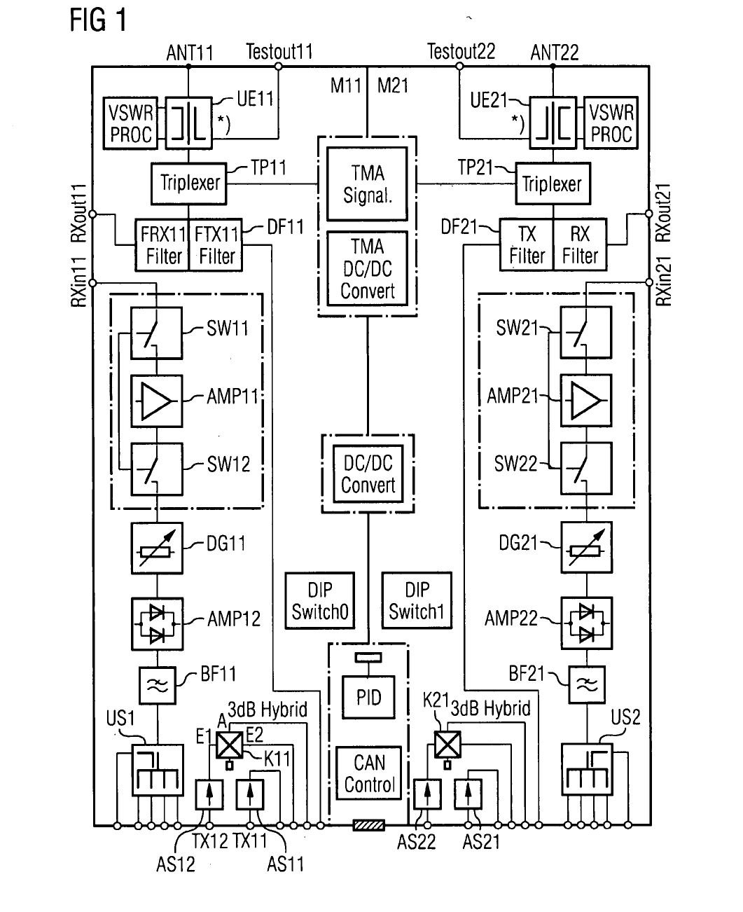

FIG. 1 shows an arrangement for connecting at least one transmitter unit to a transceiver antenna.

The arrangement is illustrated in FIG. 1 in the form of a first module M1 and includes, from a transmit-side perspective, a first one-way attenuator AS11 and a second one-way attenuator AS12, which have an input and an output in each instance, a first coupling facility or coupler K11, which has a first input E1 and second input E2 as well as an output A. The first module M11 also has a transceiver duplex filter DF11, via the transmit filter FTX11 thereof a transmission signal which is specific to a first transceiver antenna ANT11 is emitted.

The respective one-way attenuators can also be realized here as insulators or as circulators or as functionally-identical components.

The first one-way attenuator AS11 is assigned to a first transmitter unit (not illustrated here), the transmitter unit providing a first transmission signal TX11. The second one-way attenuator AS12 is assigned to a second transmitter unit (not illustrated here), the second transmitter unit providing a second transmission signal TX12.

The first input E1 of the first coupling facility or coupler K11 is connected to the output of the second one-way attenuator AS12.

The input of the first one-way attenuator AS11 and the input of the second one-way attenuator AS12 are designed for a fixed but detachable connection to the respectively assigned transmitter unit, in order to be able to receive the assigned transmission signals TX11 and TX12.

The input of the transmit filter FTX11, the second input E2 of the first coupling facility or coupler K11, the output A of the first coupling facility or coupler K11 and the output A of the first one-way attenuator AS11 are likewise designed for respective fixed but detachable connections, so that at least one of the transmission signals TX11 and/or TX12 of the respectively assigned transmitter unit can be optionally connected to the input of the transmit filter FTX11 by using the fixed but detachable connections.

The transmission signal connected to the filter FTX11 reaches the first transceiver antenna ANT11 by way of the transceiver duplex filter DF11, a triplexer TP11 and a monitoring facility UE11 having VSWR control “VSWR PROC”. The monitoring facility UE11 is used to provide a signal of an antenna port of the antenna ANT11, the signal having been attenuated by approximately 40 dB. To this end, a test signal inspection may be carried out at an output Testout11.

The fixed but detachable connections allow the first transmission signal TX11 and/or the second transmission signal TX12 to be optionally connected to transceiver antenna ANT1.

To connect the first transmission signal TX11 for instance, the assigned transmitter unit is connected to the input of the first one-way attenuator AS11 in a fixed but detachable manner. In addition, the output of the first one-way attenuator AS11 is connected to the input of the transmit filter FTX11 in a fixed but detachable manner.

To connect the two transmission signals TX11 and TX12, the first transmitter unit assigned to the first transmission signal TX11 is connected to the input of the first one-way attenuator AS11 in a fixed but detachable manner. The second transmitter unit assigned to the second transmission signal TX12 is connected to the input of the second one-way attenuator AS12 in a fixed but detachable manner.

The output of the first one way attenuator ASD11 is connected to the second input E2 of the coupling facility or coupler K11 and the output A of the coupling facility or coupler K11 is connected to the input of the transmit filter FTZ11 in a fixed but detachable manner in each instance.

From a receive-side perspective, the first module M11 has a receive filter FRX11 of the transceiver duplex filter DF11, a first switch SW11, a first amplifier AMP11, a second switch SW12, an attenuation facility DG11, a second amplifier AMP12, a filter BF11 as well as a number of parallel outputs in the form of a selection facility US1, which are connected to the output of the second amplifier AMP12.

A signal received by way of the transceiver antenna ANT11 reaches the parallel outputs by way of the monitoring facility UE11, the triplexer TP11 and by way of the above-mentioned receive-side components, the parallel outputs being able to be connected to respectively connectable receiver units and/or carrier units in a similarly fixed but detachable manner for signal evaluation purposes.

If the arrangement is realized in a second module M21 in a manner similar in terms of construction, the first module M11 and the second module M21, depending on the choice, form a “DUAMCO 2:2” or a “DUAMCO 4:2” for connecting two and/or four transmission signals to two transceiver antennae ANT11 and ANT22.

Accordingly, the second module M21 has a first one-way attenuator AS21 and a second one-way attenuator AS22, a first coupling facility or coupler K21, a transceiver duplex filter DF21, a triplexer TP21, a monitoring facility UE21, a first switch SW21, a first amplifier AMP21, a second switch SW22, an attenuation facility DF21, a second amplifier AMP22, a filter BF21 as well as a selection facility US2.

The coupling facilities K11 and/or K21 are preferably designed as 3 dB hybrid couplers. In an advantageous development, in the case of each module M11 and M21, an additional receive-side filter (not illustrated here) can be connected by way of respective ports RXout11, RXin11, RXout21 and RXin21.

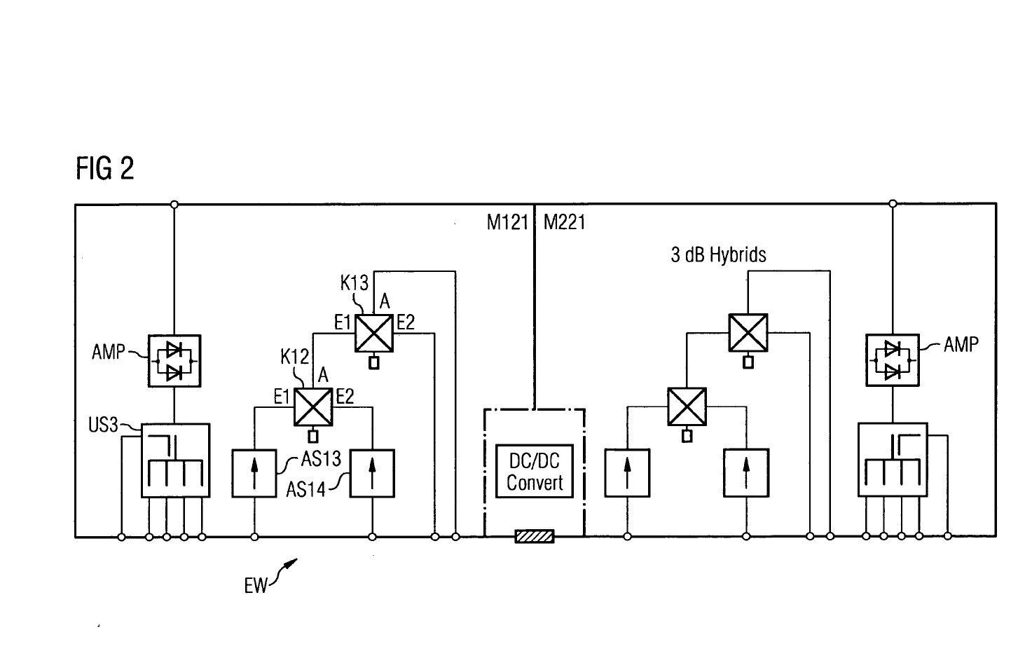

FIG. 2 shows an expansion unit EW which can be connected to the arrangement illustrated in FIG. 1 in order to connect at least three transmitter units to the transceiver antennae ANT11.

The expansion unit EW is realized as a first module M121 and includes, from a transmit-side perspective, a third one-way attenuator AS13 and a fourth one-way attenuator AS14, which each have an input and an output. Furthermore, the first module M121 contains a second coupling facility or coupler K12 and a third coupling facility or coupler K13, which each have two inputs E1 and E2 as well as an output A.

The respective inputs of the two one-way attenuators AS13 and AS14 are designed for a fixed but detachable connection to assigned transmitter units in each instance. The output of the third one-way attenuator AS13 is connected to a first input E1 of the second coupling facility or coupler K12. The output of the fourth one-way attenuator AS14 is connected to a second input E2 of the second coupling facility or coupler K12. The output A of the second coupling facility or coupler K12 is connected to a first input E1 of the third coupling facility or coupler K13. A second input E2 and the output A of the third coupling facility K13 are designed for a fixed but detachable connection.

From a receive-side perspective, the first module M12 of the expansion unit EW has an amplifier AMP and a selection facility US3.

To supply up to eight transmission signals to two transceiver antennae, a second module M221 identical in construction is provided in addition to the first module M121.

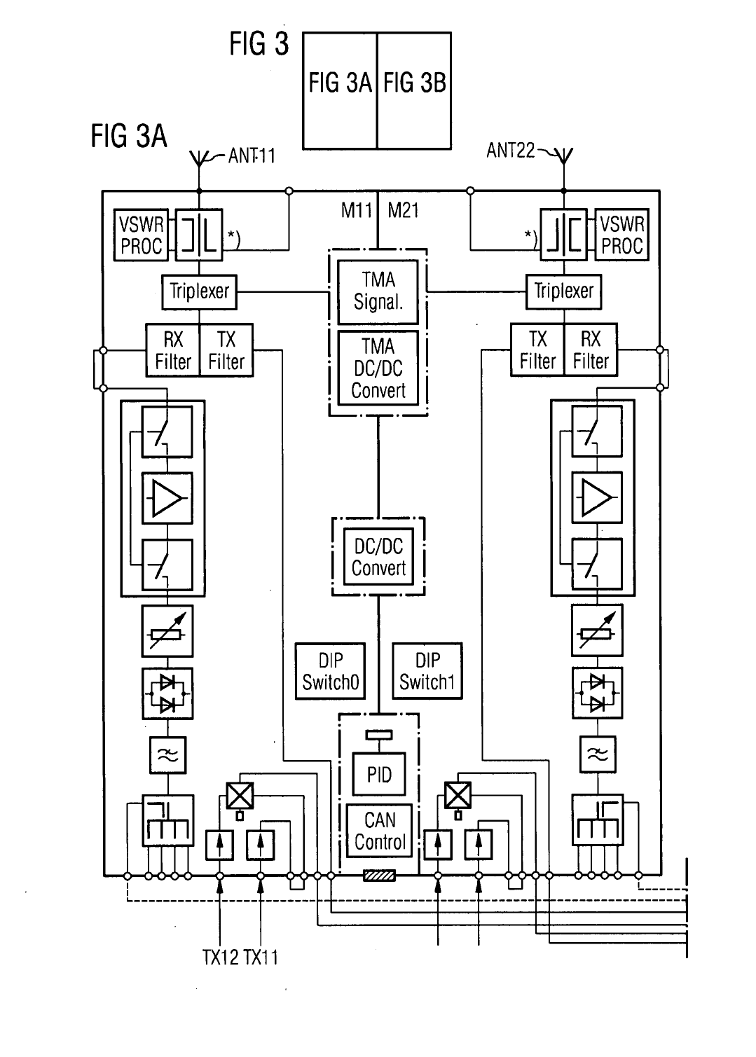

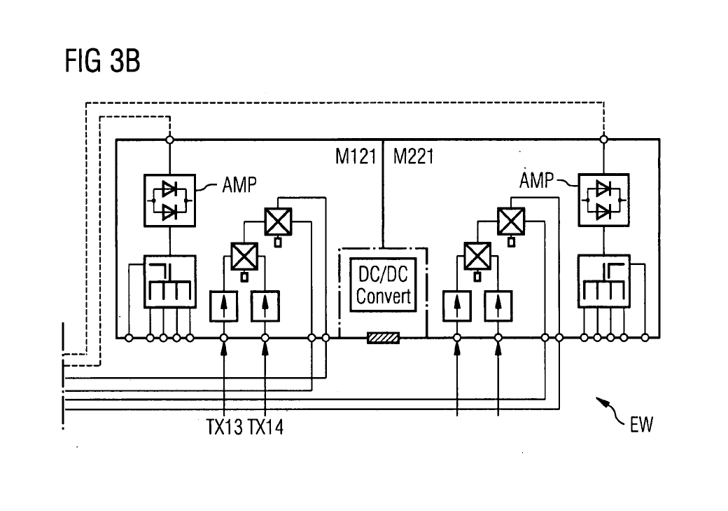

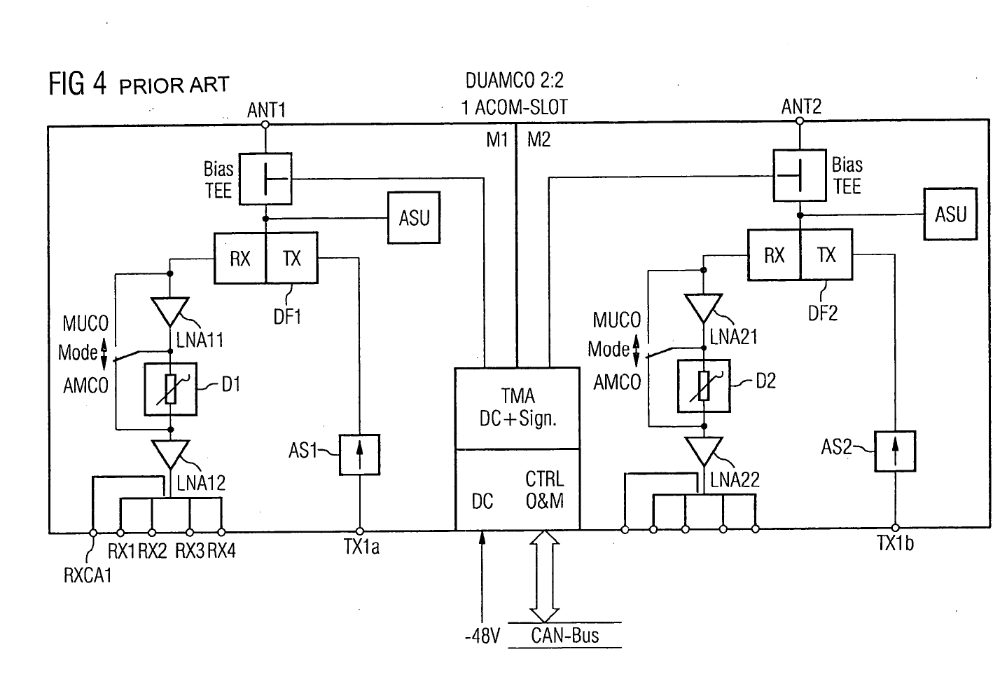

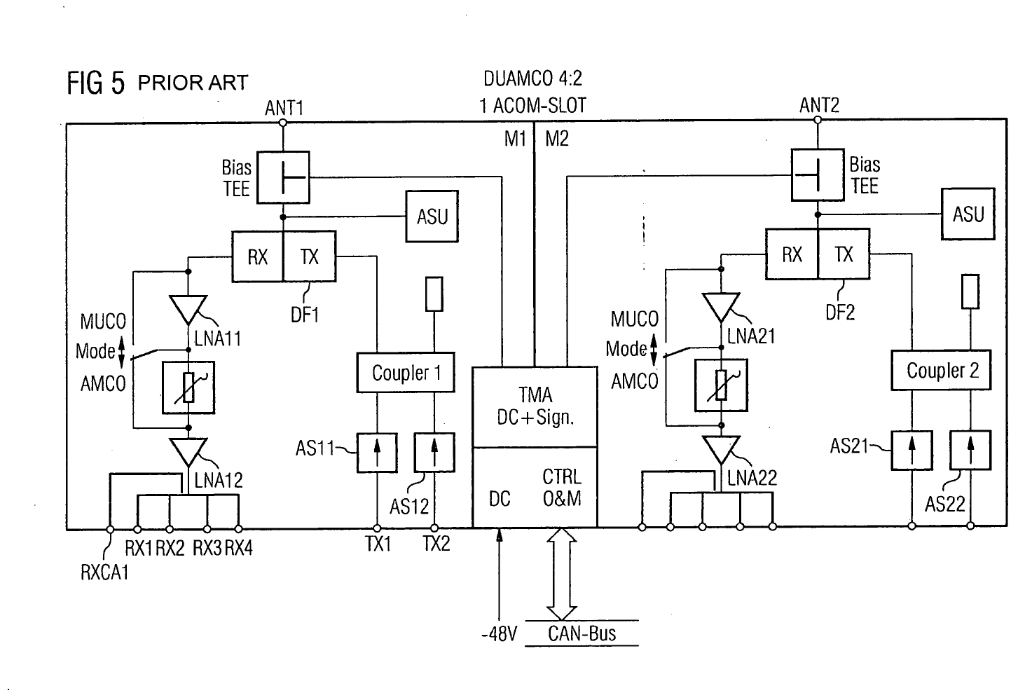

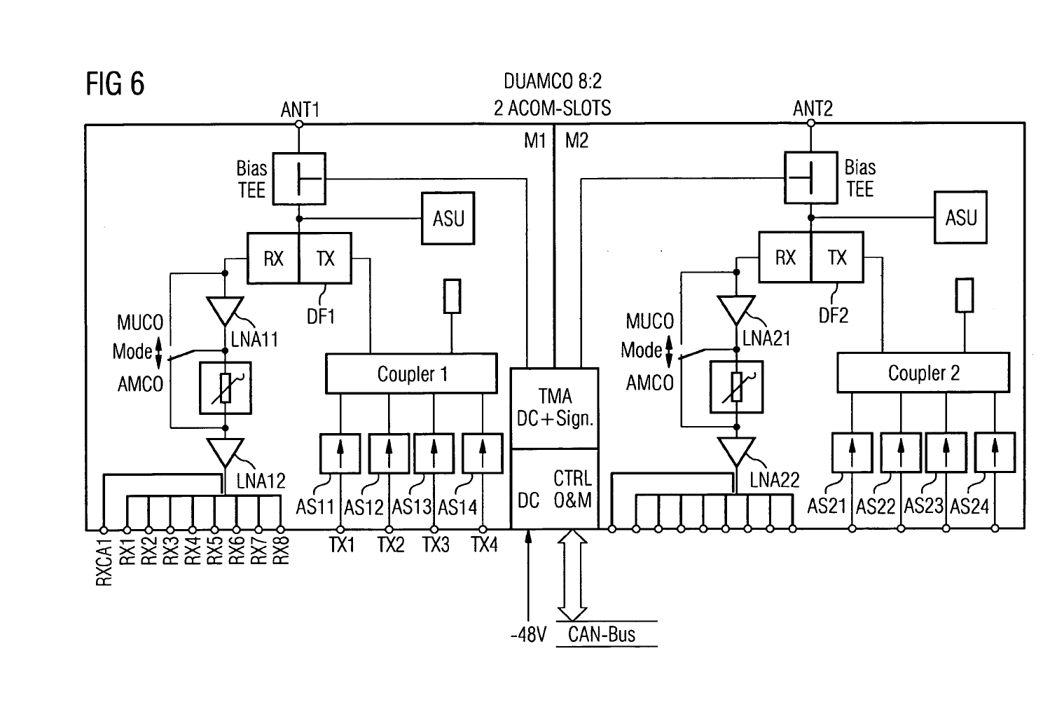

FIG. 3 shows, with reference to FIG. 1 and FIG. 2, the arrangement having a connected expansion unit EW, for feeding a total of four transmission signals TX11, TX12, TX13 and TX14 into the transceiver antenna ANT11.

In this way, a first transmitter unit (not illustrated here) assigned to the first transmission signal TX11 is connected to the input of the first one-way attenuator AS11 in a fixed but detachable manner. A second transmitter unit (not illustrated here), which is assigned to the second transmission signal TX12, is connected to the input of the second one-way attenuator AS12 in a fixed but detachable manner. A third transmitter unit (not illustrated here), which is assigned to the third transmission signal TX13, is however connected to the input of the third one-way attenuator AS13 of the first module M121 in a detachable fashion. A fourth transmitter unit (not illustrated here), which is assigned to the fourth transmitter unit TX14, is connected to the input of the fourth one-way attenuator AS14 of the first module M121 in a fixed but detachable manner.

The output of the first one-way attenuator AS11 is connected to the second input E2 of the first coupling facility or coupler K11 in a fixed but detachable manner and the output A of the first coupling facility or coupler K11 is connected to the second input E2 of the third coupling facility or coupler K13 in a fixed but detachable manner. Finally, the output A of the third coupling facility or coupler K13 is connected to the input of the transmit filter FTX11 in a fixed but detachable manner.

If the corresponding connections are in turn accommodated between the second module M22 of the arrangement from FIG. 1 and of the second module M221 from FIG. 2, a “DUAMCO 8:2” is realized to connect eight transmission signals to the two transceiver antennae ANT11 and ANT22.

In FIG. 3, the ports RXin11, RXout11, RXin21 and RXout21 described in FIG. 1 were bypassed in the respective modules.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. An apparatus connecting at least one transmitter unit to a transceiver antenna, comprising:
a transceiver duplex filter, having a transmit filter with an input and by which a transmission signal formed by the at least one transmitter unit reaches the transceiver antenna;
at least first and second one-way attenuators, each assigned to a corresponding transmitter unit, each one-way attenuator having an input and an output, the input of each one-way attenuator designed for a fixed but detachable connection to the corresponding transmitter unit; and
a first coupler having first and second inputs and an output with the first input connected to the output of the second one-way attenuator, with the input of the transmit filter, the second input and the output of the first coupler. and the output of the first one-way attenuator having fixed but detachable connections providing a detachable connection for transmission of at least one transmission signal of an assigned transmitter unit to the input of the transmit filter.

11. The apparatus as claimed in claim 10, wherein when a single transmission signal is transmitted, the assigned transmitter unit is connected to the input of the first one-way attenuator and the output of the first one-way attenuator is connected to the input of the transmit filter in a fixed but detachable manner.

12. The apparatus as claimed in claim 10, wherein when two transmission signals are transmitted, connections are made in a fixed but detachable fashion as follows:
a first transmitter unit is connected to the input of the first one-way attenuator,
a second transmitter unit is connected to the input of the second one-way attenuator,
the output of the first one-way attenuator is connected to the second input of the first coupler, and
the output of the first coupler is connected to the input of the transmit filter.

13. The apparatus as claimed in claim 10, further comprising an additional expansion unit provides connections by way of fixed but detachable connections provided for a total of four transmission signals.

14. The apparatus as claimed in claim 13, wherein the expansion unit comprises:
third and fourth one-way attenuators, each having an output and an input providing a fixed but detachable connection to the corresponding transmitter unit; and
second and third couplers, each having first and second inputs and an output, with the first input of the second coupler connected to the output of the third one-way attenuator, the second input of the second coupler connected to the output of the fourth one-way attenuator, the output of the second coupler connected to the first input of the third coupler, and the second input and the output of the third coupler providing a fixed but detachable connection.

15. The apparatus as claimed in claim 14, wherein when four transmission signals are transmitted, connections are made in a fixed but detachable fashion as follows:
a first transmitter unit is connected to the input of the first one-way attenuator,
a second transmitter unit is connected to the input of the second one-way attenuator,
a third transmitter unit is connected to the input of the third one-way attenuator,
a fourth transmitter unit is connected to the input of the fourth one-way attenuator,
the output of the first one-way attenuator is connected to the second input of the first coupler, and the output of the first coupler is connected to the second input of the third coupler, and
the output of the third coupler is connected to the input of the transmit filter.

16. The apparatus as claimed in claim 15, wherein the couplers are 3 dB hybrid couplers having an unused port terminated with a load resistor.

17. The apparatus as claimed in claim 16,
further comprising a first selection circuit, amplifiers and filters, and
wherein the transceiver duplex filter further includes a receive filter, coupled to the selection circuit by way of the amplifiers and filters, by way of which a received signal output by the transceiver antenna reaches the first selection circuit via the amplifiers and filters.

18. The apparatus as claimed in claim 17, wherein the expansion unit further comprises a second selection circuit, connected to the first selection circuit, performing signal evaluation.
